(19) United States
(12) Patent Application Publication
(10) Pub. No.: US 2025/0153467 A1
(43) Pub. Date: May 15, 2025

(54) LAMINATE FOR VEHICLE INTERIOR MATERIAL

(71) Applicants: HYUNDAI MOTOR COMPANY, Seoul (KR); Kia Corporation, Seoul (KR); HANWHA ADVANCED MATERIALS CORPORATION, Seoul (KR)

(72) Inventors: Eun Ju Noh, Hwaseong-si (KR); Jae Hyun An, Hwaseong-si (KR); In Soo Han, Uiwang-si (KR); Ju Wan Lim, Hwaseong-si (KR); Jong Taek Na, Sejong-si (KR); Je Beom Yeon, Cheongju-si (KR); Min Hyuk Kim, Sejong-si (KR)

(73) Assignees: HYUNDAI MOTOR COMPANY, Seoul (KR); Kia Corporation, Seoul (KR); HANWHA ADVANCED MATERIALS CORPORATION, Seoul (KR)

(21) Appl. No.: 18/436,672

(22) Filed: Feb. 8, 2024

(30) Foreign Application Priority Data
Nov. 13, 2023 (KR) 10-2023-0156090

(51) Int. Cl. B32B 27/08; B32B 3/30; B32B 5/18; B32B 27/18; B32B 27/30; B32B 27/32; B32B 27/40; B32B 37/12; B32B 37/15; B32B 38/00

(52) U.S. Cl. CPC B32B 27/08; B32B 3/30; B32B 5/18; B32B 27/18; B32B 27/30; B32B 27/322; B32B 27/40; B32B 37/1284; B32B 37/153; B32B 38/164; B32B 2250/05; B32B 2250/24; B32B 2305/022; B32B 2307/3065; B32B 2307/536; B32B 2307/54; B32B 2307/7376; B32B 2369/00; B32B 2375/00; B32B 2605/003

(57) ABSTRACT

Proposed is a laminate including a base layer, a second layer positioned on the base layer, and a first layer positioned on the second layer, in which the first layer includes a polycarbonate-based polyurethane, and the second layer includes a thermoplastic polyurethane. The thermoplastic polyurethane has an elongation at break of 400% or less and a melt index of 80 to 140 g/10 min at a temperature of 185° C. and a load of 2.16 kg.

### CROSS-REFERENCE TO RELATED APPLICATION

The present application claims priority to Korean Patent Application No. 10-2023-0156090, filed Nov. 13, 2023, the entire contents of which is incorporated herein for all purposes by this reference.

### BACKGROUND OF THE PRESENT DISCLOSURE

### Field of the Present Disclosure

The present disclosure relates to a laminate for a vehicle interior material.

### Description of Related Art

Materials capable of achieving a texture similar to that of artificial leather are being applied to improve the quality of vehicle interior materials. Among vehicle interiors, crash pads complete the front part of a vehicle. In the case of a vehicle equipped with a passenger-side airbag, a crash pad provides a means to deploy a passenger-side airbag.

Of all the materials applicable to such crash pads, polyurethane (PU) has a problem in that low-temperature airbag deployment performance is difficult to be obtained. Additionally, polyvinyl chloride (PVC) has environmental problems due to the use of plasticizers, and there may be concerns about deterioration in long-term heat resistance. Thermoplastic polyolefin (TPO) may result in poor sensory quality, such as surface touch and cushioning.

In vehicle interior materials such as crash pads, there is a need to develop materials capable of obtaining all of the low-temperature airbag deployment performance, vacuum formability, long-term heat resistance, and sensory quality while minimizing cost increases.

The information disclosed in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing a laminate and a crash pad being vacuum-formable by obtaining processability while having good sensory quality and physical properties related to airbag deployment at low temperatures and room temperature.

Objectives of the present disclosure are not limited to the objective mentioned above. The above and other objectives of the present disclosure will become more apparent from the following description and will be realized by the means of the appended claims, and combinations thereof.

To achieve the object described above, a laminate, according to an exemplary embodiment of the present disclosure, includes a base layer, a second layer positioned on the base layer, and a first layer positioned on the second layer, in which the first layer includes a polycarbonate-based polyurethane, the second layer includes a thermoplastic polyurethane, and the thermoplastic polyurethane has an elongation of 400% or less and a melt index of 80 to 140 g/10 min at a temperature of 185° C. and a load of 2.16 kg.

In the exemplary embodiment of the present disclosure, the thermoplastic polyurethane may have an elongation at break of 250% to 370%.

In the exemplary embodiment of the present disclosure, the second layer may include 5 to 20 parts by weight of a phosphorus-based flame retardant with respect to 100 parts by weight of thermoplastic polyurethane.

In the exemplary embodiment of the present disclosure, the second layer may have a thickness of 0.15 to 0.45 mm.

In the exemplary embodiment of the present disclosure, the first layer may have a thickness of 0.03 to 0.25 mm.

In the exemplary embodiment of the present disclosure, a certain laminate including the first layer positioned on the second layer may have a Shore A 15 hardness of 55 to 80.

In the exemplary embodiment of the present disclosure, a certain laminate including the first layer positioned on the second layer may have a Young's modulus at 100% elongation of 58 to 82 kgf/cm² and a tensile strength of 100 to 151 kgf/cm².

In the exemplary embodiment of the present disclosure, a certain laminate including the first layer positioned on the second layer may have an elongation at break of 204% to 400%.

In the exemplary embodiment of the present disclosure, the laminate may have a tensile strength of 17 to 39 kgf/cm² and an elongation at break of 207% to 300%.

In the exemplary embodiment of the present disclosure, the laminate excluding the base layer may have a thickness of 0.25 to 0.6 mm.

In the exemplary embodiment of the present disclosure, an adhesive layer may be further included between the base layer and the second layer.

To achieve the object described above, a laminate for a vehicle interior material, according to another exemplary embodiment of the present disclosure, includes a back layer, a foam layer positioned on the back layer, an adhesive layer positioned on the foam layer, a second layer positioned on the adhesive layer, a first layer positioned on the second layer, and a surface treatment layer positioned on the first layer, in which the first layer includes a polycarbonate-based polyurethane, the second layer includes a thermoplastic polyurethane, the thermoplastic polyurethane has an elongation at break of 400% or less and a melt index of 140 g/10 min or less at a temperature of 185° C. and a load of 2.16 kg.

In the exemplary embodiment of the present disclosure, the laminate for the vehicle interior material may be applied as a crash pad of a vehicle.

In the exemplary embodiment of the present disclosure, the back layer may include any one selected from the group consisting of a polyurethane resin, a chlorinated polypropylene resin, an acrylic resin, and combinations thereof.

In the exemplary embodiment of the present disclosure, the surface treatment layer may have an uneven surface having a plurality of depressions and protrusions.

According to an exemplary embodiment of the present disclosure, a vacuum-formable laminate and crash pad of a vehicle having sensory quality and excellent airbag deployment capability can be implemented.

The laminate, according to an exemplary embodiment of the present disclosure, can be applied to a crash pad of a vehicle by omitting a so-called skin-scoring process to improve airbag deployment capability.

Effects of the present disclosure are not limited to the effect mentioned above. It should be understood that the effects of the present disclosure include all the effects which can be deduced from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1A and FIG. 1B are images of a crash pad to which a laminate, according to one aspect of the present disclosure, is applied;

FIG. 2 is a schematic diagram briefly illustrating a process of manufacturing a laminate according to one aspect of the present disclosure;

FIG. 3A and FIG. 3B are schematic diagrams briefly illustrating a laminate according to one aspect of the present disclosure; and

FIG. 4 is a schematic diagram briefly illustrating a laminate for a vehicle interior material according to one aspect of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Above objectives, other objectives, features, and advantages of the present disclosure will be readily understood from the following exemplary embodiments associated with the accompanying drawings. However, the present disclosure is not limited to the embodiments described herein and may be embodied in other forms. The embodiments described herein are provided so that the present disclosure can be made thorough and complete and that the spirit of the present disclosure can be fully conveyed to those skilled in the art.

Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise.

It will be further understood that the terms “comprises”, “includes”, or “has” when used in the present specification specify the presence of stated features, regions, integers, steps, operations, elements, and/or components, but do not preclude the presence or addition of one or more other features, regions, integers, steps, operations, elements, components and/or combinations thereof.

It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in the present specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In vehicle interior materials, polyvinyl chloride (PVC) has been applied as an interior material for general purposes. However, there are problems with long-term heat resistance performance and environmental issues due to the use of plasticizers. In the present disclosure, these problems and issues have been solved, and a laminate including a polycarbonate-based polyurethane and a thermoplastic polyurethane having a predetermined melt index while having sensory quality, vacuum formability, and physical properties related to airbag deployment at low temperatures and room temperature has been developed. Hereinafter, the description thereof is to be detailed.

### Laminate 100

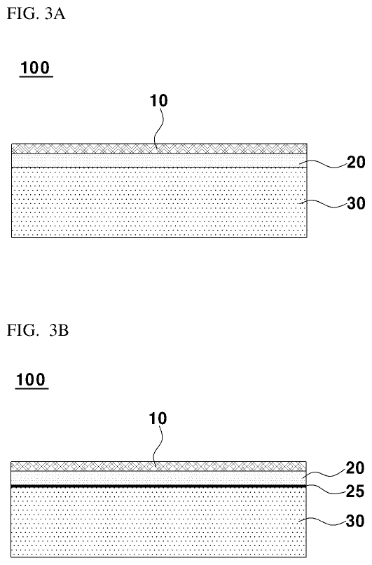

Referring to FIG. 3A, FIG. 3B and the like, a laminate 100, according to one aspect of the present disclosure, includes a base layer 30, a second layer 20 positioned on the base layer 30, and a first layer 10 positioned on the second layer. The first layer 10 includes a polycarbonate-based polyurethane, the second layer 20 includes a thermoplastic polyurethane, and the thermoplastic polyurethane has an elongation at break of 400% or less and a melt index of 100 to 140 g/10 min at a temperature of 185° C. and a load of 2.16 kg.

The melt index may be a melt flow index and measured at a temperature of 185° C. and a load of 2.16 kg according to ASTM D 1238.

The thermoplastic polyurethane of the second layer 20 may have a melt index of 100 to 140 g/10 min, or 110 to 130 g/10 min. Thermoplastic polyurethanes having such melt index may be easily formable when applied to a crash pad and contribute to obtaining low-temperature airbag deployment performance (at −35° C.) in the crash pad. When the melt index does not fall within the above range, the low-temperature airbag deployment performance (at −35° C.) of the crash pad may be deteriorated or delayed, and pattern transfer capability during forming may be poor.

The thermoplastic polyurethane of the second layer 20 may have a room-temperature elongation at break (at 23° C.) of 400% or less, or 370% or less, according to ASTM D412. The thermoplastic polyurethane may have an elongation at break of 250% or more. Thermoplastic polyurethanes with such elongation at break may contribute to obtaining airbag deployment performance when applied to a crash pad.

The second layer 20 may include 5 to 20 parts by weight of a phosphorus-based flame retardant with respect to 100 parts by weight of the thermoplastic polyurethane.

The phosphorus-based flame retardant of the second layer 20 may include a phosphonate.

The second layer 20 may have a thickness of 0.15 to 0.45 mm, or 0.2 to 0.4 mm. The second layer 20 having such thickness may be in an appropriate combination with the first layer 10 and the base layer 30 and contribute to obtaining formability and low-temperature airbag deployment performance when applied to a crash pad.

The thermoplastic polyurethane of the second layer 20 may be manufactured by extruding the resulting product obtained through reacting a polyol component having a predetermined molecular weight with an isocyanate and a chain extender into a sheet form. Alternatively, the thermoplastic polyurethane may be manufactured by being extruded into a sheet form using a partially polymerized thermoplastic polyurethane chip (pallet) having the melt index described above.

A thermoplastic polyurethane resin may include components derived from a polyester polyol, a polyether polyol, and the like as polyol-derived components and may include components derived from a polyol having a weight average molecular weight (Mw) of 1000 or more and 5000 or less.

The thermoplastic polyurethane resin may include toluene diisocyanate (TDI), methylene diphenyl diisocyanate (MDI), isophorone diisocyanate (IPDI), hexamethylene diisocyanate, aliphatic isocyanate, and the like as isocyanate-based components.

The thermoplastic polyurethane resin may include ethylene glycol (EG), diethylene glycol (DEG), propylene glycol (PG), 1,4-butanediol, 1,6-hexanediol, diethanolamine, triethanolamine, methyl pentanediol, isophoronediamine, and the like as chain extender-derived components.

A composition for preparing the thermoplastic polyurethane resin may include 50 to 80 wt % of a polyol component, 15 to 35 wt % of an isocyanate-based component, 5 to 15 wt % of the chain extender, and may include additives, such as other inorganic fillers, paraffin wax, and polyethylene wax.

The polycarbonate-based polyurethane of the first layer 10 may be formed by applying and treating a mixture including 30 to 70 parts by weight of a solvent with respect to 100 parts by weight of the polycarbonate-based polyurethane resin or a composition for preparing the same. The solvent may include dimethylformamide (DMF), dimethylacetamide (DMAC), dimethyl sulfoxide (DMSO), and the like.

The polycarbonate-based polyurethane resin may include polycarbonate polyol-derived components as polyol-derived components and may further include components derived from a polyether polyol, a polyester polyol, and the like.

The polycarbonate-based polyurethane resin may include toluene diisocyanate (TDI), methylene diphenyl diisocyanate (MDI), isophorone diisocyanate (IPDI), hexamethylene diisocyanate, and the like as isocyanate-derived components.

The polycarbonate-based polyurethane resin may include components derived from isophorone diamine, ethylene glycol (EG), diethylene glycol (DEG), propylene glycol (PG), 1,4-butanediol, 1,6-hexanediol, diethanolamine, triethanolamine, methylpentanediol, and the like as components derived from the chain extender and a crosslinker and may include components derived from polyamines, triols, tetraols, and the like.

The composition for preparing the polycarbonate-based polyurethane resin may include 65 to 75 wt % of a polyol component, 15 to 25 wt % of an isocyanate-based component, and 10 to 15 wt % of the chain extender plus the crosslinker.

The first layer 10, a polycarbonate-based polyurethane coating layer, may be formed through a process of mixing the polycarbonate-based polyurethane resin or the composition for preparing the same with a solvent, applying the resulting product on the second layer 20, and eluting the solvent by being washed with water and the like.

The first layer 10 may further include a pigment and may, for example, include any one selected from the group consisting of azo-based pigment, anthraquinone-based pigment, phthalocyanine-based pigment, perinone-based pigment, perylene-based pigment, indigo-based pigment, thioindigo-based pigment, dioxadine-based pigment, quinacridone-based pigment, isoindolinone-based pigment, isoindoline-based pigment, diketopyrrolopyrrole-based pigment, and combinations thereof.

The first layer 10 may selectively further include a UV inhibitor, a light stabilizer, an antioxidant, a surfactant, and the like.

The first layer 10 may have a thickness of 0.03 to 0.25 mm, or 0.05 to 0.20 mm. The first layer 10 having such thickness may be in an appropriate combination with the second layer 20 and contribute to obtaining excellent touch and cushioning performance when applied to a crash pad.

A certain laminate including the first layer 10 positioned on the second layer 20 may have a Shore A 15 hardness of 55 to 80, or 60 to 78, according to ASTM D2240.

The certain laminate may have a Young's modulus at 100% elongation of 58 to 82 kgf/cm², or 60 to 80 kgf/cm².

The certain laminate may have a tensile strength of 100 to 151 kgf/cm², or 105 to 140 kgf/cm².

The certain laminate may have an elongation at break of 204% to 400%, or 230% to 350%.

The certain laminate may have a tear strength of 3.4 to 5.7 kgf/mm, or 3.6 to 5.5 kgf/mm.

The laminate 100 may have a Shore C 15 hardness of 50 to 70, or 52 to 65, according to ASTM D2240.

The laminate 100 may have a Young's modulus at 100% elongation of 9 to 31 kgf/cm², or 11 to 29 kgf/cm².

The laminate 100 may have a tensile strength of 17 to 39 kgf/cm², or 20 to 36 kgf/cm².

The laminate 100 may have an elongation at break of 207% to 300%, or 210% to 249%.

The Young's modulus at 100% elongation, tensile strength, elongation at break, and the like may be measured at room temperature according to ASTM D412, and the tear strength may be measured at room temperature according to ASTM D624.

Any of the laminates and the laminate 100 have these physical properties, enabling the laminate 100 to obtain appropriate formability and airbag deployment capability.

The base layer 30 may be a foam layer made of a foamed resin, polypropylene resin, polyethylene resin, polybutene resin, ethylene-propylene copolymer, or polyurethane resin.

The base layer 30 may have a thickness of 2 to 6 mm, or 2.5 to 4 mm. The base layer 30 may have a foaming magnification of 8 to 20 times. By having such thickness, the laminate 100 may enable a desired form to be maintained and contribute to obtaining airbag deployment capability, cushioning of the material, and dimensional stability after forming a product when applied to a crash pad.

The laminate 100 may further include an adhesive layer 25 positioned between the base layer 30 and the second layer 20.

The adhesive layer 25 may include a polyurethane resin, a polyamide resin, an ethylene vinyl acetate resin, a styrene-based resin, an epoxy-based resin, an acrylic resin, a polyolefin resin, and combinations thereof as a binder resin.

The adhesive layer 25 may, for example, include a polyurethane resin, and a BTX (benzene, toluene, and xylene)-free solvent may be applied thereto. When mixing an adhesive layer composition, a crosslinker may be additionally used. Additionally, the composition may be prepared by mixing 10 to 20 parts by weight of the crosslinker and 5 to 15 parts by weight of the solvent, with respect to 100 parts by weight of the resin.

The adhesive layer 25 may provide excellent adhesive strength between the base layer 30 and the second layer 20 and obtain long-term durability of the laminate.

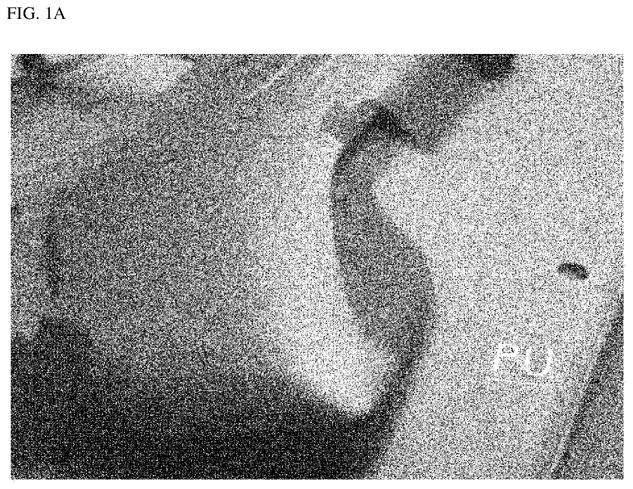

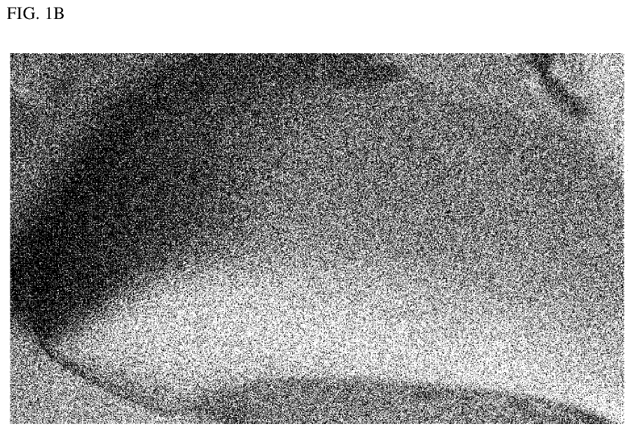

As shown in FIG. 1A and FIG. 1B, the laminate 100 may have formability that makes it easy to be applied to a crash pad of vehicles, airbag deployment means, and adjacent parts, and may have good airbag deployment capability at a low temperature (−35° C.) and room temperature (23° C.).

### Laminate for Vehicle Interior Material 101

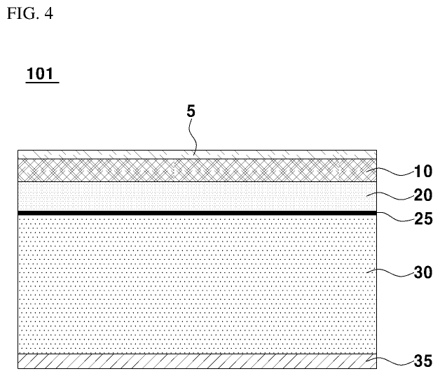

Referring to FIG. 4 and the like, a laminate 101 for a vehicle interior material, according to another aspect of the present disclosure, includes a back layer 35, a foam layer 30 positioned on the back layer 35, an adhesive layer 25 positioned on the foam layer 30, a second layer 20 positioned on the adhesive layer 25, a first layer 10 positioned on the second layer 20, and a surface treatment layer 5 positioned on the first layer 10. The first layer 10 includes a polycarbonate-based polyurethane, the second layer 20 includes a thermoplastic polyurethane, and the thermoplastic polyurethane has an elongation at break of 400% or less and a melt index of 140 g/10 min or less at a temperature of 185° C. and a load of 2.16 kg.

The first layer 10, the second layer 20, and the adhesive layer 25 of the laminate 101 for the vehicle interior material may be the same as those of the laminate 100 described above.

The foam layer 30 of the laminate 101 for the vehicle interior material may be the same as the base layer 30 of the laminate 100 described above.

The surface treatment layer 5 may have an uneven surface with a pattern having a plurality of depressions and protrusions.

The surface treatment layer 5 may have a thickness of 0.001 to 0.5 mm.

The surface treatment layer 5 may be formed by spray coating, gravure coating, and the like and may also be processed using a roller with a predetermined pattern.

The surface treatment layer 5 may include a polyurethane resin, a chlorinated polypropylene resin, an acrylic resin, and the like.

The back layer 35 may include a polyurethane resin, a chlorinated polypropylene resin, an acrylic resin, and the like, as well as those with modified surfaces, and may include a surface-modified polyurethane resin. The surface-modified polyurethane resin may, for example, include a polycarbonate-based polyurethane resin, a polyester-based polyurethane resin, a polyether-based polyurethane resin, and the like. In this case, the polyurethane resin may be modified by including a crosslinker and a silicone compound. The crosslinker may include one or more selected from the group consisting of an aziridine group an isocyanate group, and a carbodiimide group, and the silicone compound may include polysiloxane.

The back layer 35 may have a thickness of 0.001 to 0.5 mm, or 0.001 to 0.1 mm.

Vehicle interior materials and crash pads may undergo a skin-scoring process to obtain airbag deployment performance. Such a process may be mainly performed by a process using a hot knife, a cold knife, milling, and the like. This skin-scoring process may cause problems, such as cost increases, exposure of outer seam lines, and the like. A crash pad to which the laminates 100 and 101, according to each aspect of the present disclosure, are applied may enable an airbag to deploy without involving a separate scoring process.

### Method of Manufacturing Laminate for Vehicle Interior Material

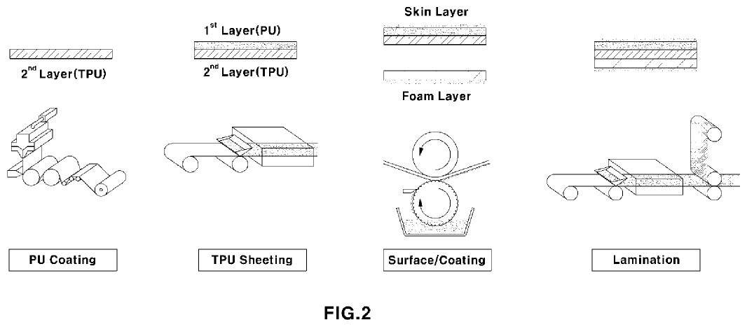

Referring to FIG. 2 and the like, a method of manufacturing a laminate for a vehicle interior material, according to one aspect of the present disclosure, includes (a) extruding a second raw material mixed with a thermoplastic polyurethane resin, (b) rolling the resulting extruded product into a second layer having a predetermined thickness, (c) forming a first layer by adding a first raw material mixed with a polycarbonate-based polyurethane resin to the second layer and then processing the resulting product, (d) performing surface treatment on the first layer and then forming a back layer on one side of the base layer, and (e) applying an adhesive on the one side of the base layer and then bonding the resulting layer to a lower surface of the second layer.

In this case, when only the laminate 100 is to be manufactured, the (d) may be omitted.

The second raw material in the (a) may include the thermoplastic polyurethane resin or a composition for preparing the same, unpolymerized monomers, and polymerized chips. The composition for preparing the thermoplastic polyurethane may be the same as that of the laminate 100 described above.

An extrusion temperature in the (a) may be in a range of 150° C. to 180° C.

The rolling in the (b) may be performed by passing through a calendar roll. Through the rolling in the (b), the second layer having a desired thickness may be formed.

The first raw material in the (c) may include the polycarbonate-based polyurethane resin or a composition for preparing the same and a solvent, which may be the same as those of the laminate 100 described above.

The (c) may include a process of applying the first raw material on the moving second layer and drying the resulting product at a temperature of 50° C. to 150° C.

The surface treatment in the (d) may be performed by adding a separate resin raw material through spray coating, gravure coating, and the like, or may be performed using a roller with a separate pattern. The resin involved in the surface treatment may be the same as that in the surface treatment layer 5 of the laminate 100 described above.

The formation of the back layer in the (d) may be completed by adding a separate resin raw material through spray coating, gravure coating, and the like. The resin involved in the formation of the back layer may be the same as that in the back layer 35 of the laminate 101 for the vehicle interior material described above.

The base layer in (d) may be a foam layer and may be the same as that in the base layer 30 of the laminate 100 described above.

The adhesive in the (e) may include components of the adhesive layer of the laminate 100 described above.

In the (e), separate heat treatment may not be performed other than the heat of the adhesive itself.

Hereinafter, the present disclosure will be described in detail with reference to the following Examples and Comparative Examples. However, the spirit of the present disclosure is not limited thereto.

### Example 1

(a) Using a thermoplastic polyurethane chip having an elongation at break of 337% according to ASTM D412 and a melt index (at a temperature of 185° C. and a load of 2.16 kg) of 130 g/10 min, T-die extrusion at 170° C. with a calendar roll was performed to form a 0.25 mm-thick thermoplastic polyurethane layer (second layer).

(b) While transferring the second layer, a mixture including 50 parts by weight of dimethylformamide (DMF) with respect to 100 parts by weight of a polycarbonate-based polyurethane resin was applied on the second layer. Then, the resulting product was subjected to heat treatment and drying at a temperature of 60° C. to 130° C. to form a 0.05 mm-thick polycarbonate-based polyurethane layer (first layer/second layer).

When mixing the polycarbonate-based polyurethane resin mixture, 30 parts by weight of black ink with respect to 100 parts by weight of the resin was introduced, stirred at high speed, and left at room temperature for 1 to 2 days for a natural defoaming process. The color difference was minimized by stirring the naturally defoamed resin mixture at low speed.

Next, a urethane-based adhesive was applied on the exposed surface of the base layer, and a polypropylene foam layer having a thickness of 3 mm and a foaming magnification of 15 was bonded to manufacture a laminate.

### Example 2

A laminate was manufactured by changing the thickness of the first layer to 0.1 mm and the thickness of the second layer to 0.2 mm in Example 1.

### Example 3

A laminate was manufactured by changing the thickness of the first layer to 0.2 mm and the thickness of the second layer to 0.2 mm in Example 1.

### Example 4

A laminate was manufactured by changing the thickness of the first layer to 0.1 mm and the thickness of the second layer to 0.4 mm in Example 1.

### Example 5

A laminate was manufactured by changing the thickness of the first layer to 0.1 mm and the thickness of the second layer to 0.3 mm in Example 1.

### Comparative Example 1

A composition was prepared by omitting the process of forming the first layer and setting the thickness of the second layer to 0.3 mm in Example 1.

### Comparative Example 2

A composition was prepared by applying a 0.3 mm-thick layer including a polycarbonate-based polyurethane, instead of the first layer/second layer in Example 1.

### Comparative Example 3

A composition was prepared by applying a 0.3 mm-thick layer including a polycarbonate-based polyurethane having an elongation at break of 562% according to ASTM D412 and a melt index (at a temperature of 185° C. and a load of 2.16 kg) of 80 g/10 min, instead of the first layer/second layer in Example 1.

### Comparative Example 4

A composition was prepared by applying a 0.6 mm-thick layer including a thermoplastic polyolefin-based material, including polypropylene and styrene-based components, instead of the first layer/second layer in Example 1.

### Comparative Example 5

A composition was prepared by applying a 0.1 mm-thick polycarbonate-based polyurethane layer formed on a 0.4 mm-thick polyvinyl chloride layer, instead of the first layer/second layer in Example 1.

### Experimental Example 1

The formability, sense of touch, low-temperature airbag deployment performance, and cost competitiveness of Examples 1 to 4 and Comparative Examples 1 to 3 were examined in the presence of artificial leather experts and measured as follows. The results thereof are shown in Table 1.

X: weak, Δ: Ambiguous, ∘: Good, ⊚: Excellent

For the low-temperature airbag deployment performance (at −35° C.), whether an airbag tore toward the seam line of a crash pad and then deployed was evaluated by installing a passenger-side airbag module according to Hyundai Motor Company's ES84500-13 and applying an electric signal to the inflator detonator for an explosion.

TABLE 1

| | | Sense | Low-temperature | Cost |
|---|---|---|---|---|
| | | of | airbag deployment | competitive- |
| Classification | Formability | touch | performance | ness |
| Example 1 | ◯ | ◯ | ⊚ | ◯ |
| Example 2 | ◯ | ⊚ | ⊚ | ⊚ |
| Example 3 | Δ | ⊚ | ◯ | ◯ |
| Example 4 | ⊚ | ⊚ | Δ | Δ |
| Comparative | ⊚ | Δ | Δ | Δ |
| Example 1 | | | | |
| Comparative | Δ | ◯ | X | ⊚ |
| Example 2 | | | | |
| Comparative | Δ | ◯ | X | ⊚ |
| Example 3 | | | | |

Referring to Table 1, in the polycarbonate-based polyurethane (PU)/thermoplastic polyurethane (TPU) structure, it was confirmed that examples in which the TPU had a predetermined melt index and elongation at break typically had good formability and excellent sensory quality, such as touch, low-temperature airbag deployment performance, and the like.

In Comparative Examples 2 and 3, in which typical polyurethane and thermoplastic polyurethane having a high elongation at break were applied, the airbag did not deploy, or the airbag deployed late. Additionally, the pattern transfer capability was degraded, resulting in poor formability.

In Comparative Example 1 free of the first layer, sensory quality, such as the sense of touch, and airbag deployment performance were confirmed to be poor.

### Experimental Example 2

The tensile strength, elongation at break, tear strength, low-temperature tensile strength (at −35° C.), and low-temperature elongation at break (at −35° C.) of Examples 2, 4, and 5 and Comparative Examples 4 and 5 were measured. The results thereof are shown in Table 2. Measurement other than at a low temperature was performed at room temperature (23° C.).

The tensile strength, elongation at break, low-temperature tensile strength, and low-temperature elongation at break were measured according to Hyundai Motor Company's component test standards MS 220 and ASTM D412, and the tear strength was measured according to ASTM D624. The longitudinal direction corresponds to the machine direction, the length direction of the sheet (film) when manufacturing each material, and the transverse direction corresponds to the vertical direction of the longitudinal direction.

TABLE 2

| | | | | | | | Low- | | Low- | |
|---|---|---|---|---|---|---|---|---|---|---|
| | Tensile | | Elongation at | | | | temperature | | temperature | |
| | strength | | break | | Tear strength | | tensile strength | | elongation at | |
| | (kgf/cm²) | | (%) | | (kgf/mm) | | (kgf/cm²) | | break (%) | |
| Classification | Longitudinal | Transverse | Longitudinal | Transverse | Longitudinal | Transverse | Longitudinal | Transverse | Longitudinal | Transverse |
| Comparative | 28 | 23 | 275 | 240 | 1.8 | 1.6 | 48 | 40 | 68 | 53 |
| Example 4 | | | | | | | | | | |
| Comparative | 42 | 38 | 323 | 358 | 2.0 | 1.3 | 65 | 54 | 126 | 137 |
| Example 5 | | | | | | | | | | |
| Example 2 | 28 | 23 | 333 | 274 | 1.3 | 1.2 | 59 | 44 | 146 | 138 |
| Example 4 | 29 | 22 | 320 | 250 | 1.3 | 1.2 | 56 | 43 | 124 | 94 |
| Example 5 | 32 | 23 | 293 | 225 | 1.5 | 1.2 | 49 | 38 | 83 | 55 |

Referring to Table 2, Examples 2, 4, and 5 showed tensile strength and elongation at break not inferior to those of comparative examples, to which the polyolefin-based resin and the polyvinyl chloride-based resin were applied, and low tear strength. Accordingly, the physical properties related to airbag deployment at low temperatures and room temperature were confirmed to be obtained.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A laminate comprising:
a base layer;
a second layer positioned on the base layer; and
a first layer positioned on the second layer,
wherein the first layer comprises a polycarbonate-based polyurethane,
wherein the second layer comprises a thermoplastic polyurethane, and
wherein the thermoplastic polyurethane has an elongation at break of 400% or less and a melt index of 80 to 140 g/10 min at a temperature of 185° C. and a load of 2.16 kg.

2. The laminate of claim 1, wherein the thermoplastic polyurethane has an elongation at break of 250% to 370%.

3. The laminate of claim 1, wherein the second layer comprises 5 to 20 parts by weight of a phosphorus-based flame retardant with respect to 100 parts by weight of the thermoplastic polyurethane.

4. The laminate of claim 1, wherein the second layer has a thickness of 0.15 to 0.45 mm.

5. The laminate of claim 1, wherein the first layer has a thickness of 0.03 to 0.25 mm.

6. The laminate of claim 1, wherein a certain laminate comprising the first layer positioned on the second layer has a Shore A 15 hardness of 55 to 80.

7. The laminate of claim 1, wherein a certain laminate comprising the first layer positioned on the second layer has a Young's modulus at 100% elongation of 58 to 82 kgf/cm² and a tensile strength of 100 to 151 kgf/cm².

8. The laminate of claim 1, wherein a certain laminate comprising the first layer positioned on the second layer has an elongation at break of 204% to 400%.

9. The laminate of claim 1, wherein the laminate has a tensile strength of 17 to 39 kgf/cm² and an elongation at break of 207% to 300%.

10. The laminate of claim 1, wherein the laminate excluding the base layer has a thickness of 0.25 to 0.6 mm.

11. The laminate of claim 1, further comprising an adhesive layer positioned between the base layer and the second layer.

12. A laminate for a vehicle interior material, the laminate comprising:
a back layer;
a foam layer positioned on the back layer;
an adhesive layer positioned on the foam layer;
a second layer positioned on the adhesive layer;
a first layer positioned on the second layer; and
a surface treatment layer positioned on the first layer,
wherein the first layer comprises a polycarbonate-based polyurethane,
wherein the second layer comprises a thermoplastic polyurethane, and
wherein the thermoplastic polyurethane has an elongation at break of 400% or less and a melt index of 140 g/10 min or less at a temperature of 185° C. and a load of 2.16 kg.

13. The laminate of claim 12, wherein the laminate is applied to a crash pad of a vehicle.

14. The laminate of claim 12, wherein the back layer comprises any one selected from the group consisting of a polyurethane resin, a chlorinated polypropylene resin, an acrylic resin, and combinations thereof.

15. The laminate of claim 12, wherein the surface treatment layer has an uneven surface having a plurality of protrusions and depressions.

16. The laminate of claim 12, wherein the back layer has a thickness of 0.001 to 0.5 mm, or 0.001 to 0.1 mm.

17. The laminate of claim 12, wherein the surface treatment layer has a thickness of 0.001 to 0.5 mm.

18. A method of manufacturing the laminate of claim 12, the method comprising:
(a) extruding a second raw material mixed with a thermoplastic polyurethane resin;
(b) rolling a resulting extruded product into a second layer having a predetermined thickness;
(c) forming a first layer by adding a first raw material mixed with a polycarbonate-based polyurethane resin to the second layer and then processing a resulting product;
(d) performing surface treatment on the first layer and then forming a back layer on one side of a base layer; and
(e) applying an adhesive on the one side of the base layer and then bonding a resulting layer to a lower surface of the second layer.

19. The method of claim 18, wherein an extrusion temperature in the (a) is in a range of 150° C. to 180° C.

20. The method of claim 18, wherein the (c) included applying the first raw material on the moving second layer and drying the resulting product at a temperature of 50° C. to 150° C.
